(19) United States
(12) Patent Application Publication
(10) Pub. No.: US 2003/0189598 A1
(43) Pub. Date: Oct. 9, 2003

(54) System and method for displaying window contents

(75) Inventors: Shawn Lipstein, Ottawa (CA); Laura Olac, Ottawa (CA); Rex Fang Xu, Waterloo (CA); Jennifer Fraser, Ottawa (CA)

Correspondence Address: Hayes, Soloway, 130 W. Cushing Street, Tucson, AZ, 85701, US

(73) Assignee: COREL CORPORATION

(21) Appl. No.: 10/119,278

(22) Filed: Apr. 9, 2002

(51) Int. Cl. G09G 5/00

(52) U.S. Cl. 345/781

(57) ABSTRACT

An anchor manager is described for providing a window for presenting window contents. It comprises a pane provider, an anchor indicator and a coupler. The pane provider provides multiple panes, each containing window contents. The anchor indicator provider provides multiple anchor indicators, each representing its related window contents. The coupler associates an anchor indicator to a pane that contains window contents represented by the anchor indicator so as to allow display of the panes in a display area of the window according to selection of the anchor indicators.

This invention relates to a user interface, and more particularly, to a system and method for displaying window contents.

### BACKGROUND OF THE INVENTION

Many computer applications provide a user interface that allows users to select or set parameters of controls of the applications. For example, a typical graphic application provides users with controls for setting shapes, lines, fill colours and other graphical parameters. The information of such controls are often presented to users through a specialized window. Window contents are typically categorized in groups, and one or more categories are contained in a pane. When a user takes a predetermined action, the window is opened and window contents are presented to the user.

A window has a display area of a limited size. When there are many panes or large panes in a window, the display area is often too small to display all panes at once and some categories of window contents may be obscured. For example, a window 10 shown in FIG. 1A has a display area 15 and four panes 20-23. Due to the limited size of the display area 15, only two panes 20 and 21 can be viewed. When all panes are not displayed, it is not easy for users to select or access a desired control.

Some existing user interfaces use dockets to present specific options and information related to the users immediate task. The dockets are organized using “tabs”. Tabs can at times confuse the user and obstruct the workflow. As well, this solution creates wasted real-estate that can be a valuable commodity.

Some existing systems use a “roll-up roll-down” technique to present window contents in order to simplify and organize the users workflow. Although the “roll-up roll-down” technique offers useful solutions in many situations, there are issues of usability. For example, in some cases one may need to scroll just to present all available options. The window shown in FIG. 1A also has a scroll bar 30 to adapt the “roll-up roll-down” technique. As shown in FIG. 1B, a user needs to scroll the window to see panes 22 and 23 in the display area 15.

In order to solve this problem, some existing systems use collapsable panes to present available options at once in a display area of the window. However, this solution still have the same drawback as the above “roll-up rolldown” technique when the collapsable panes are expanded.

It is therefore desirable to provide a system for providing window contents such that users can easily and quickly access a desired category of the window contents.

### SUMMARY OF THE INVENTION

It is an object of the invention to provide a novel system and method for displaying window contents that obviates or mitigates at least one of the disadvantages of existing systems.

The present invention uses an anchor mechanism that brings a desired category of window contents into a display area of a window.

In accordance with an aspect of the present invention, there is provided a window contents display system for displaying window contents on a computer monitor. The system comprises a window provider, a coupler, an input receiver and a pane. The window provider provides a window containing multiple panes for presenting window contents, and one or more anchor indicators. Each anchor indicator represents its corresponding window contents. The coupler associates each anchor indicator to a pane that contains window contents represented by the anchor indicator. The input receiver receives a selection of an anchor indicator. The pane display controller displays, in response to the selection of an anchor indicator, a pane that is associated with the selected anchor indicator in an display area.

In accordance with another aspect of the present invention, there is provided an anchor manager for providing a window for presenting window contents. The anchor manager comprises a pane provider, an anchor indicator and a coupler. The pane provider provides multiple panes, each containing window contents. The anchor indicator provider provides multiple anchor indicators, each representing its related window contents. The coupler associates an anchor indicator to a pane that contains window contents represented by the anchor indicator so as to allow display of the panes in a display area of the window according to selection of the anchor indicators.

In accordance with another aspect of the present invention, there is provided a window contents presenting user interface for presenting window contents. The user interface comprises a window, multiple panes and multiple anchor indicators. The window has a display area and an anchor indicator area. The panes are capable of being displayed in the display area of the window. Each pane contains window contents. The anchor indicators are provided on the anchor indicator area of the window. Each anchor indicator is associated with a pane that contains related window contents, and selectable by a user such that selection of an anchor indicator causes display of its associated pane.

In accordance with another aspect of the present invention, there is provided a method for providing a window for presenting window contents. The method comprises steps of providing multiple panes, each containing window contents, providing multiple anchor indicators, each representing its related window contents, and associating an anchor indicator to a pane that contains window contents represented by the anchor indicator so as to allow display of the panes in a display area of the window according to selection of the anchor indicators.

In accordance with another aspect of the present invention, there is provided a computer readable medium storing the instructions or statements for use in the execution in a computer of the method for providing a window for presenting window contents.

In accordance with another aspect of the present invention, there are provided electronic signals for use in the execution in a computer of the method for providing a window for presenting window contents.

In accordance with another aspect of the present invention, there is provided a computer program product for use in the execution in a computer of a method for providing a window for presenting window contents. The computer program product comprises a module for providing multiple panes, each containing window contents, a module for providing multiple anchor indicators, each representing its related window contents, and a module for associating an anchor indicator to a pane that contains window contents represented by the anchor indicator so as to allow display of the panes in a display area of the window according to selection of the anchor indicators.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1A is a diagram showing an example of a window of an existing user interface;

FIG. 1B is a diagram showing scrolling of the window for the example shown in FIG. 1A;

FIG. 2 is a diagram showing a window contents display system in accordance with an embodiment of the present invention;

FIG. 3A is a diagram showing an example of a window in accordance with an embodiment of the present invention;

FIG. 3B is a diagram showing displaying of panes for the embodiment shown in FIG. 3A;

FIG. 4 is a flowchart showing a method of displaying information in accordance with an embodiment of the invention; and

FIG. 5 is a diagram showing an example of an anchor button.

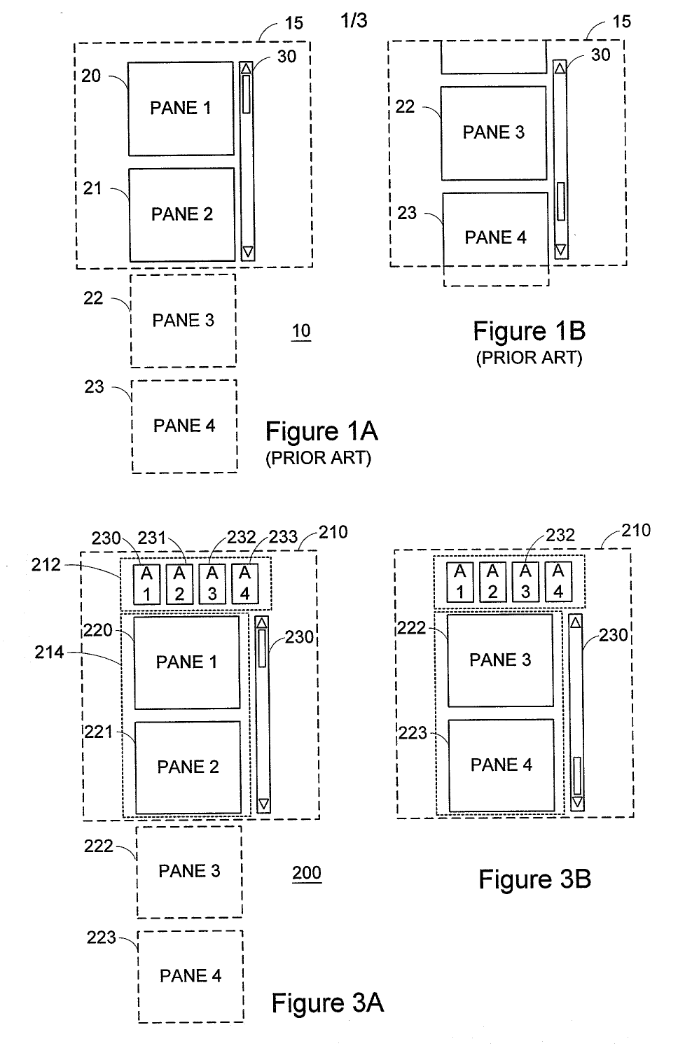

### DETAILED DESCRIPTION OF THE PREFERRED EMBODIMENTS

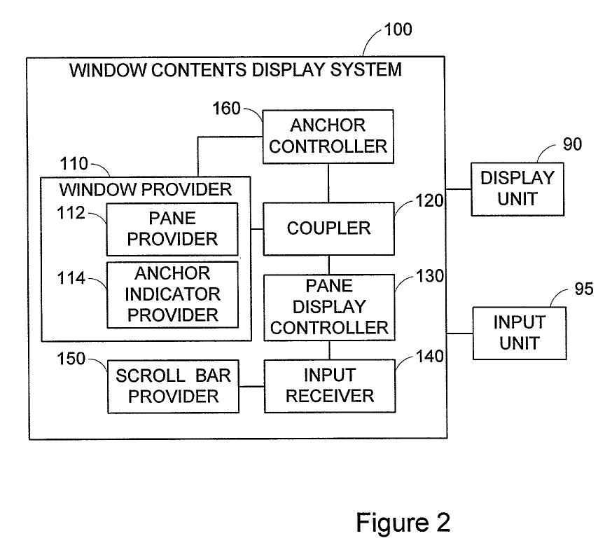

Referring to FIG. 2, a window contents display system for an application in accordance with an embodiment of the present invention is described. The window contents display system 100 displays window contents on a display unit 90. It receives user input through an input unit 95. The input unit 95 may be a mouse, keyboard, touch screen or any other suitable input device. The system 100 uses an anchor mechanism to display on the display device 90 a selected category of window contents in response to the user input, as further described below.

The window contents display system 100 includes an anchor manager containing a window provider 110 and a coupler 120, a pane display controller 130 and an input receiver 140. The window provider 110 provides a window for presenting window contents to users. The window has a display area. Window contents may be any type of information regarding the application or environments of the application. For example, window contents may be one or more controls for the application. A control may including a list of available options, parameters to be set, the status of current settings or any other information of the application, or a combination of these information.

The window provider 110 has a pane provider 112 and an anchor indicator provider 114 for providing one or more panes and anchor indicators in the window. An anchor indicator is a hybrid of a selectable area, such as button or tab, and an anchor, as described below. The coupler 120 couples or associates each anchor indicator with its related pane. The pane display controller 130 displays one or more panes in the display area of the window.

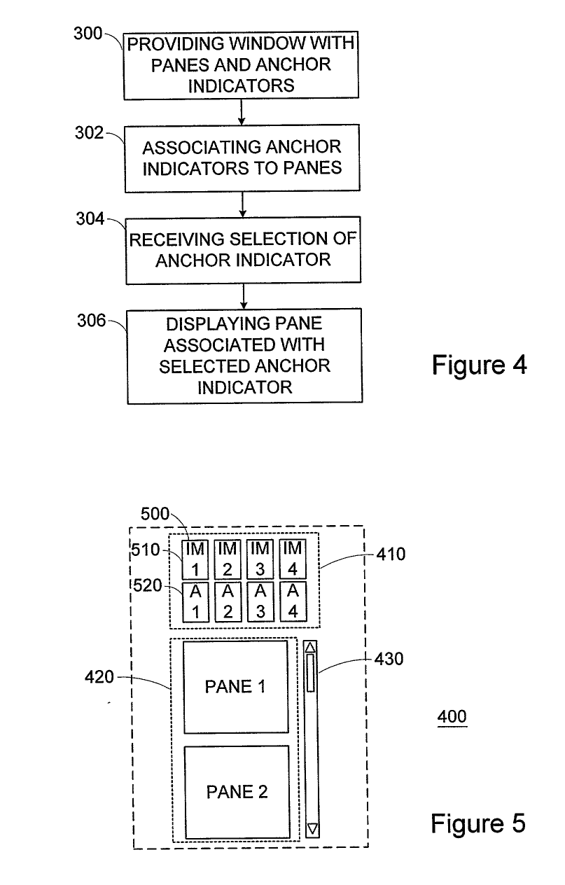

The window contents display system 100 is further described referring to FIG. 4 using an example of a window shown in FIG. 3A.

The window provider 110 provides a window 200 to present window contents to users (300). The window 200 may be collapsible, and it may be expanded when a user takes a predetermined action. The window 200 has a display area 210. The display area 210 has an anchor indicator area 212 and a pane area 214.

The window 200 contains four panes 220-223 in this example. Due to the limited size of the display area 210, panes 220 and 221 are displayed in the pane area 214, but panes 222 and 223 are not displayed. A pane may be a specialized window itself. It may contain one or more categories of window contents. For example, it may contain various controls, such as buttons and combo boxes. Each pane may be coded as a derivation from a dialogue window. It may be collapsible or expansible to hide or show the window contents contained in the pane. The size of each pane may vary depending on the contents. The pane area 214 of the display area 210 may be a scrollable area to bring various panes to the user view.

The window 200 also has four anchor indicators 230-233 displayed in the anchor indicator area 212. Each anchor indicator 230, 231, 232 or 233 represents a related category or categories of window contents. An anchor indicator may be a bitmap button, tab or an area that can be selected by the user. It may include an image or name representing the category or categories of web contents.

The coupler 120 couples or associates each anchor indicator 230, 231, 232 or 233 with a related pane 220, 221, 222 or 223 that contains the category or categories of window contents represented by the anchor indicator (302).

When a user selects an anchor indicator, the input receiver 140 receives the selection through the input unit 95 (304). In response to the user selection, the pane display controller 130 automatically displays in the pane area 214 of the display area 210 a desired pane that is associated with the selected anchor indicator (306). The pane display controller 130 may bring the desired pane in the display area 210 by automatically scrolling or jumping the panes. For example, as shown in FIG. 3B, when a user selects anchor indicator 232, its associated pane 222 is automatically displayed in the pane area 214.

Thus, the window contents display system 100 provides an anchor mechanism that brings a desired pane up in the display area. This allows the user to quickly access a desired category of window contents that may be obscured by window size limits.

In the above example, four panes and four anchor indicators are shown, but the number of panes or anchor indicators may vary depending on desired window contents or designs. Panes in a window may have the same size or different sizes. The panes are arranged in a line in the example shown in FIG. 303A, but they may be in a different arrangement, such as a matrix.

As shown in FIGS. 2 and 3A, the system 100 may also have a scroll bar provider 150, and the window 200 may have a scroll bar 230 that allows users to manually scroll the various panes.

In the example shown in FIG. 3A, for each pane contained in a window, an anchor indicator is provided. In that case, all available options of panes may be presented visually as a set of anchor indicators in the anchor area of the display area of the window. Thus, users do not have to scroll up and down the windows to know available options.

The window contents display system 100 may allow a user to add, delete or modify anchor indicators, panes and their associations. To this end, the system 100 may have an anchor controller 160 as shown in FIG. 2. The user may set parameters of the anchor controller 160, such as the bitmap image to be displayed as an anchor indicator, and the associated pane to be added in the window 200. The order in which each pane is added may determine the order in which the anchor indicators and their associated panes are shown in the window 200. Alternatively, the anchor controller 160 may allow a user to set the order of the anchor indicators and their associated panes.

In the example shown in FIG. 3A, the anchor indicators 231-233 are shown on the top of the display area 210 of the window 200. They may be provided in a different location in the display area 210.

The association between each anchor indicator and its related pane contained in the window may be accomplished by using many types of visual cues, some of which may include color, icons and text.

FIG. 5 shows another example of a window 400. The window 400 has an anchor indicator area 410, a pane display area 420 and a scroll bar 430. In the anchor indicator area 410, an anchor indicator is provided for each related pane. In this embodiment, an anchor indicator has two sections.

Each anchor indicator 500 has an image button 510 and an anchor button 520. The image button 510 can be clicked to show or hide its associated pane. It includes an image or name representing the category or categories of contents contained in the associated pane. The anchor button 520 may be also a bitmap button. It may be clicked to bring its associated pane into view in the pane display area.

In the above examples, buttons are shown as anchor indicators. However, the invention may use different forms to indicate selectable areas to use the anchor mechanism.

As described above, the window contents display system allows users to find information and access controls that may not be visible thereby improving workflow by eliminating scrolling up or down.

The window contents display system of the present invention may be implemented by any hardware, software or a combination of hardware and software having the above described functions.

For example, when the system is coded in Microsoft Foundation Library (MFC), the anchor button window control may be derived form the class CWnd. In that case, a space at a predetermined position, e.g., the top, of the window is reserved as an anchor indicator area for drawing anchor buttons and/or image buttons. This anchor indicator area may be set as a non-client area of the window. The rest of the window space may be used as a client area and contain various panes to be displayed. A scroll bar of the CWnd class may be used in the window.

The anchor indicators, such as buttons, may be drawn in a variety of ways, e.g., using the various CDC functions, and displayed in the anchor indicator area.

The panes may be derived from the class CDialog. CDialog is a specialized window control that can contains various other controls, such as buttons and combo boxes. The panes are associated with or parented to their corresponding anchor indicators. They are contained in the associated anchor indicator control, and displayed in the display area of the window when their associated anchor indicators are selected.

The automatic scrolling or jumping of the various panes may be handled by code AnchorButtonCtrl. When the user selects an anchor button, the various panes move in the AnchorButtonCtrl to display the associated pane in the display area of the window.

The code implementing the window contents display system, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention. For example, the elements of the window contents displaying system have been described separatory, however, two or more elements may be provided as a single element, or one or more elements may be shared with other component in other computer systems.

What is claimed is:

1. A window contents display system for displaying window contents on a computer monitor, the system comprising:
a window provider for providing a window containing multiple panes for presenting window contents, and one or more anchor indicators, each anchor indicator representing its corresponding window contents;
a coupler for associating each anchor indicator to a pane that contains window contents represented by the anchor indicator;
an input receiver for receiving a selection of an anchor indicator; and
a pane display controller, in response to the selection of an anchor indicator, for displaying a pane that is associated with the selected anchor indicator in an display area.

2. The window contents display system as claimed in claim 1, wherein the window is a scrollable window, and the pane display controller automatically scrolls the window to display the pane that is associated with the selected anchor indicator.

3. The window contents display system as claimed in claim 1, wherein the window provider provides the anchor indicators as anchor buttons that are selectable by a user.

4. The window contents display system as claimed in claim 3, wherein the window provider provides the anchor indicators that include images representing window contents that is represented by the anchor indicators.

5. The window contents display system as claimed in claim 1 further comprising a scroll bar provider for providing a scroll bar for manually scrolling the window.

6. The window contents display system as claimed in claim 1 further comprising an anchor controller that allows adding, deleting or changing of an anchor indicator and its associated pane.

7. An anchor manager for providing a window for presenting window contents, the anchor manager comprising:
a pane provider for providing multiple panes, each containing window contents;
an anchor indicator provider for providing multiple anchor indicators, each representing its related window contents; and
a coupler for associating an anchor indicator to a pane that contains window contents represented by the anchor indicator so as to allow display of the panes in a display area of the window according to selection of the anchor indicators.

8. The anchor manager as claimed in claim 7, wherein the anchor indicator provider provides the anchor indicators as anchor buttons that are selectable by a user.

9. The anchor manager as claimed in claim 8, wherein the anchor indicator provider provides an anchor to include an image that represents window contents represented by the anchor indicator.

10. The anchor manager as claimed in claim 7, wherein the anchor indicator provider provides anchor indicators such that each has a first indicator for controlling appearance of its associated pane and a second indicator for displaying its associated pane in the display area of the window.

11. The anchor manager as claimed in claim 10, wherein the anchor indicator provider provides the first indicator as an image button having an image representing its associated pane, and the second indicator as an anchor button that allows display of its associated pane in the display area of the window.

12. The anchor manager as claimed in claim 7 further comprising an anchor controller that allows adding, deleting or changing of an anchor indicator and its associated pane.

13. A method for providing a window for presenting window contents, the method comprising steps of:
providing multiple panes, each containing window contents;
providing multiple anchor indicators, each representing its related window contents; and
associating an anchor indicator to a pane that contains window contents represented by the anchor indicator so as to allow display of the panes in a display area of the window according to selection of the anchor indicators.

14. The method as claimed in claim 13 further comprising steps of:
receiving a selection of an anchor indicator; and
displaying, in response to the selection of an anchor indicator, a pane that is associated with the selected anchor indicator in an display area.

15. The method as claimed in claim 14, wherein the displaying step automatically scrolls the window to display the pane that is associated with the selected anchor indicator.

16. The method as claimed in claim 13, wherein the anchor indicator providing step provides the anchor indicators as anchor buttons that are selectable by a user.

17. The method as claimed in claim 16, wherein the anchor indicator providing step provides the anchor indicators that include images representing window contents that is represented by the anchor indicators.

18. The method as claimed in claim 13, wherein the anchor indicator providing step provides anchor indicators such that each has a first indicator for controlling appearance of its associated pane and a second indicator for displaying its associated pane in the display area of the window.

19. The method as claimed in claim 18, wherein the anchor indicator providing step provides the first indicator as an image button having an image representing its associated pane, and the second indicator as an anchor button that allows display of its associated pane in the display area of the window.

20. The method as claimed in claim 13 further comprising steps of:
providing a scroll bar for manually scrolling the window; and
allowing manual scrolling of the window.

21. The method as claimed in claim 13 further comprising a step of allowing adding, deleting or changing of an anchor indicator and its associated pane.

22. A window contents presenting user interface for presenting window contents, the user interface comprising:
a window having a display area and an anchor indicator area;
multiple panes capable of being displayed in the display area of the window, each containing window contents; and
multiple anchor indicators provided on the anchor indicator area of the window, each anchor indicator being associated with a pane that contains related window contents, each anchor indicator being selectable by a user such that selection of an anchor indicator causes display of at least a pane that is associated with the selected anchor indicator.

23. The user interface as claimed in claim 21, wherein the anchor indicators are provided as anchor buttons having images that represent window contents represented by the anchor indicators.

24. The user interface as claimed in claim 21, wherein the anchor indicators are provided such that each has a first indicator for controlling appearance of its associated pane and a second indicator for displaying its associated pane in the display area of the window.

25. The user interface as claimed in claim 23, wherein the first indicator is provided as an image button having an image representing its associated pane, and the second indicator is provided as an anchor button that allows display of its associated pane in the display area of the window.

26. A computer readable medium storing the instructions or statements for use in the execution in a computer of a method for providing a window for presenting window contents, the method comprising steps of:
providing multiple panes, each containing window contents;
providing multiple anchor indicators, each representing its related window contents; and
associating an anchor indicator to a pane that contains window contents represented by the anchor indicator so as to allow display of the panes in a display area of the window according to selection of the anchor indicators.

27. Electronic signals for use in the execution in a computer of a method for providing a window for presenting window contents, the method comprising steps of:
providing multiple panes, each containing window contents;
providing multiple anchor indicators, each representing its related window contents; and
associating an anchor indicator to a pane that contains window contents represented by the anchor indicator so as to allow display of the panes in a display area of the window according to selection of the anchor indicators.

28. A computer program product for use in the execution in a computer of a method for providing a window for presenting window contents, the computer program product comprising:
a module for providing multiple panes, each containing window contents;
a module for providing multiple anchor indicators, each representing its related window contents; and
a module for associating an anchor indicator to a pane that contains window contents represented by the anchor indicator so as to allow display of the panes in a display area of the window according to selection of the anchor indicators.
